(19) United States
(12) Patent Application Publication
(10) Pub. No.: US 2015/0123421 A1
(43) Pub. Date: May 7, 2015

(54) VEHICLE BED COVER SYSTEM AND STORAGE ASSEMBLY

(71) Applicants: Robert B. Combs, II, Ottawa, KS (US); Jeff Wittman, Ottawa, KS (US)

(72) Inventors: Robert B. Combs, II, Ottawa, KS (US); Jeff Wittman, Ottawa, KS (US)

(21) Appl. No.: 14/533,016

(22) Filed: Nov. 4, 2014

Related U.S. Application Data
(60) Provisional application No. 61/899,689, filed on Nov. 4, 2013.

(51) Int. Cl. B60J 7/14; B60J 7/20; B60J 10/10

(52) U.S. Cl. CPC B60J 7/141; B60J 10/10; B60J 7/201
USPC 296/100.02

(57) ABSTRACT

A modular cover system for a vehicle cargo bed includes a cover support frame mountable to the front wall and sidewalls of the cargo bed, a plurality of modular cover panels, and a seal configured for installation over a perimeter margin of the cover panels and the front, rear and sidewalls of the vehicle bed. Each panel is bounded by a rail, configured to include a forwardly projecting tongue and a corresponding groove at the rear. The panel rails provide sufficient support to permit removal of selected adjacent panels to provide open spaces for tall cargo. Each panel includes a latch operable to selectively secure the panel to the side bed rails or release the panel from the side bed rails, thereby enabling a user to selectively release one or more panels from the cover system.

### CROSS-REFERENCE TO RELATED APPLICATION

This application claims priority under 35 U.S.C. 119(e) and 37 C.F.R. 1.78 based upon copending U.S. Provisional Application Ser. No. 61/899,689 for VEHICLE BED COVER SYSTEM AND STORAGE ASSEMBLY filed Nov. 4, 2014, the entirety of which is incorporated herein by reference.

### FIELD OF THE INVENTION

The present invention relates to a vehicle bed cover system and storage assembly. The vehicle bed cover system and storage assembly is designed to allow a user to easily convert a cargo bed into a secure storage compartment that is weatherproof.

### BACKGROUND OF INVENTION

Trucks with open cargo beds have become popular passenger vehicles used by many for work, recreation, and leisure. Their wide ranging utility has led to the development of many accessory products designed to expand their limited storage space. While the open bed design provides versatility in the size and shape of loads that can be transported, it also creates problems. Because the bed space is entirely open, it lacks both security and protection from the elements. Further, when the tailgate is closed, the aerodynamic design of the bed is compromised, resulting in reduced vehicle fuel economy.

Many in the industry have attempted to devise coverings to minimize or eliminate the problems created by an open truck bed. Currently available soft covers constructed of fabric or plastic may ensure protection from the elements, but do not ensure security of contents within the truck bed. Currently available hard covers are typically difficult to install and remove. What is needed is a vehicle bed cover system that is easy to install and that creates a weatherproof and secure storage compartment. There is also a need for a modular system that allows a user to easily remove selected panels while leaving others in place to shelter the remainder of the cargo bed from the elements and provide security against access from the outside. There is also a need for a storage container configured to form an integral part of the vehicle bed cover system and that allows for easy storage of the panels used with the system or that can function as a separate storage compartment within the vehicle bed. There is also a need for a vehicle bed cover system that provides a separate, secure compartment for storage of personal belongings.

### BRIEF SUMMARY OF THE INVENTION

The current vehicle bed cover system and storage assembly overcomes the shortcomings of currently available cargo bed covers. The system is configured to be easy to install and employ to convert the cargo bed of a vehicle into a weatherproof and secure storage compartment. The system includes a cover support frame mountable to the front bulkhead and sidewalls of the cargo bed, including a front bed rail and a pair of opposed bed side rails. The frame supports a cover assembly including a plurality of cover panel sections. Each panel section includes a panel body bounded by a front panel rail, a pair of opposed side panel rails and a rear panel rail. The panel rails form a channel for receiving and supporting the perimeter of the panel. The forward panel rails each include a projecting tongue and the rear panel rails each include a corresponding groove for receiving the tongue of the adjacent panel. The forward bed rail includes a channel for receiving a front panel rail. The channel includes a gasket for sealing engagement of the tongue of a front panel rail. The side bedrail includes a flange for supporting the side of a panel section. The flange includes a seat supporting a seal member for sealing contact with the supported panel section. The rear panel rail groove includes a seal for sealing contact with the tongue member, thereby sealing the joint between the adjacent panels. The rear panel rails each include a latch system having a pair of laterally projecting latches connected by a cable. The latch system operates to extend the latches under the bed side rails and thereby urge the panel side rails against the bed side rails and compress the associated seals. The latches may be easily disengaged by a user to selectively release one or more panels from the cover system and uncover a selected portion of the cargo bed. A perimeter seal is configured for installation over a perimeter margin of the cover panels, the top surfaces of the support frame, and the upper rim of the tailgate.

The panel sections also include removable trim panels which may be painted or otherwise customized as desired. An optional storage canister may be provided having a front wall, rear wall, sidewalls, deck and a lid with a locking latch. The canister sidewalls include a plurality of ribs forming vertical slots to receive and store the panel sections when they are disengaged from the frame and removed from the cover assembly.

Various objects, features and advantages of this disclosure will become apparent from the following detailed description, taken in conjunction with the accompanying drawings, which depict, by way of illustration and example, certain embodiments of this vehicle bed cover system and storage assembly.

The drawings constitute a part of this specification, include exemplary embodiments of the invention, and illustrate various objects and features thereof.

### BRIEF DESCRIPTION OF THE DRAWINGS

FIG. 1 is a perspective view of a vehicle and cargo bed with a bed cover system and storage assembly embodying the present invention. The bed cover is shown in a partially open position.

FIG. 2 is a top plan view of a bed cover and storage system installed on a cargo bed.

FIG. 3 is an elevational view showing a cargo bed front rail connected to a bed side rail.

FIG. 4 is a side view of a cargo bed side rail.

FIG. 5 is a side view of a cargo bed side rail with details of one embodiment of a latch assembly.

FIG. 6 is a side sectional view of front and rear panel rails with trim panels installed.

FIG. 7 is a perspective view of a panel section showing an alternate embodiment of a latch assembly.

FIG. 8 is a perspective view side showing details of installation of panel sections on a left bed side rail with perimeter seal.

FIG. 9 is a perspective view of a cargo bed with storage canister showing panel sections stored within the canister.

### DETAILED DESCRIPTION OF THE INVENTION

As required, detailed embodiments of the vehicle bed cover system and storage assembly are disclosed herein. However, the disclosed embodiments are provided for illustration only and are merely exemplary of the system, which may be embodied in various forms. Therefore, specific structural and functional details disclosed herein are not to be interpreted as limiting, but merely as a basis for the claims and as a representative basis for teaching one skilled in the art to variously employ the system apparatus in virtually any appropriately detailed structure.

Certain terminology is used in the following description for convenience and in reference only, and is not intended to be limiting. For example, the words, “right” and “left” refer to directions in the drawings to which reference is made.

Referring to the drawings, the reference number 1 generally designates a vehicle bed cover system and storage assembly for use in association with a vehicle 2 such as a pickup truck or the like, having a cab 3 and a cargo area or bed 4. The pickup cargo bed 4 includes a deck or floor 5, left and right opposed bed sidewalls 10 and 11, a forward or front wall or bulkhead 12, which may or may not be integral with the rear wall of the cab, and a rear wall or tailgate 13 that may be lowered for rear access to the bed. While the cab 3 and bed 4 are generally constructed as separate structures, the vehicle bed cover system 1 may also be employed with coupe-utility or body-on-frame type vehicles in which the cab and cargo bed are both integrated into the body of the vehicle. It is also foreseen that the system 1 may be employed in association with any other type of cargo bed, such as a trailer, that may be pulled by a car, truck, motorcycle or bicycle, or a railroad car that may be pulled by a train.

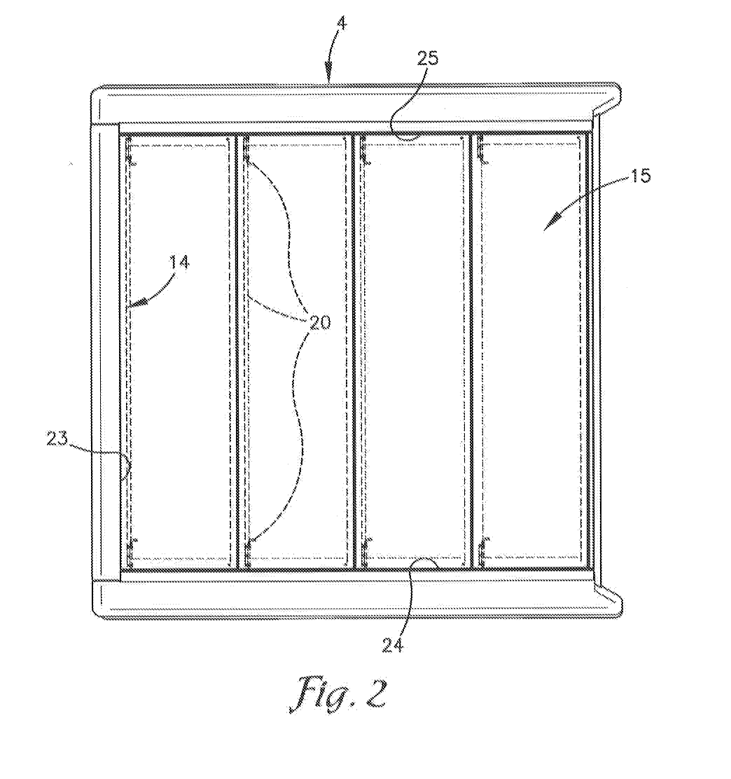

The system 1 includes a mounting frame 14 which is attached to the bed 4 and supports a cover assembly 15, a latch assembly 20, (FIG. 2), a perimeter seal 21 and an optional storage container or canister 22 which may also include a latch assembly.

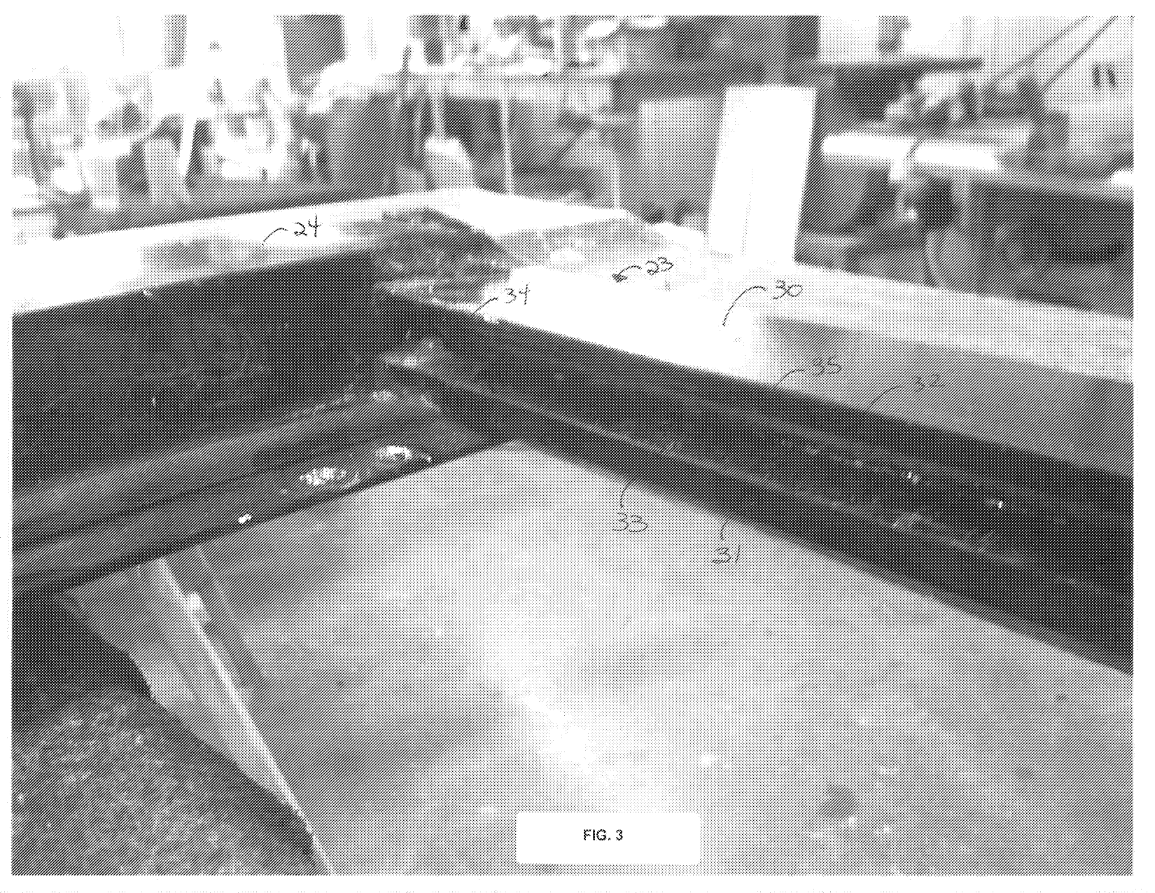

The frame 14 includes a forward or front bed rail 23, (FIG. 2) and a pair of opposed left and right bed side rails 24, 25. In one embodiment, the frame 14 is prefabricated with each end of the front bed rail pivotally connected to the end of a respective side rail to enable collapse of the frame into a folded configuration for transport and/or storage, and unfolding of the frame for easy installation. In another embodiment, the rails 23, 24 and 25 are supplied as separate components for individual installation and removal. The bed forward rail 23 (FIG. 3) is approximately I-shaped, and includes top and bottom flanges 30 and 31 interconnected by a short web 32 to form a channel 33. The outboard ends of the bottom flange 31 are apertured to receive fasteners 34 that are used to connect the forward bedrail with the side bedrails. The bed front rail 23 is connected to the bulkhead of the cargo bed by fasteners such as bolts or the like. The channel formed between the flanges and the short web is equipped with a gasket 35. The frame members are constructed of extruded aluminum, although any other suitable material, such as other metals and certain synthetic resins and synthetic resin-fiber compositions may be employed.

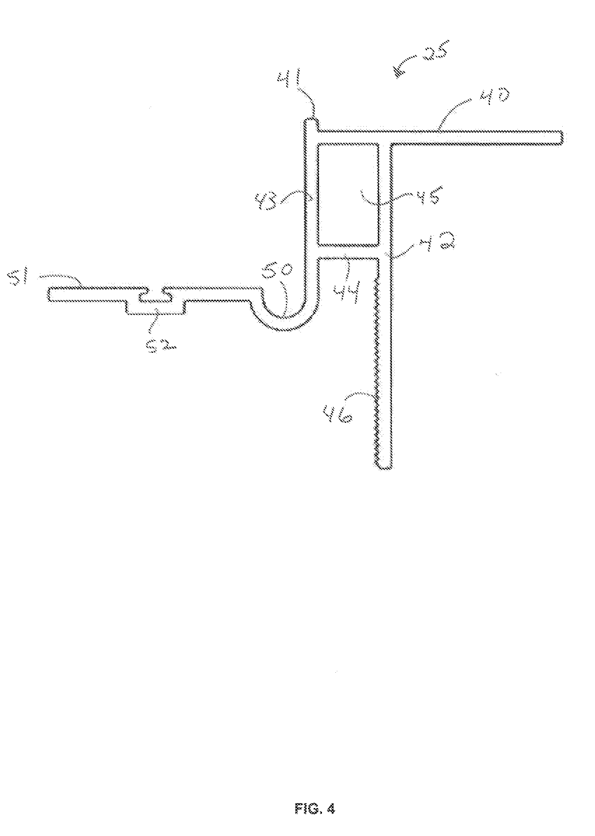

As best shown in FIG. 4, each of the bed side rails 24 and 25 includes a top flange 40 with an inboard upstanding lip 41 to prevent entry of moisture over the top flange 40. An outboard leg 42 depends from the top flange 40 for positioning adjacent the inner sidewall of the cargo bed 4. The inner surface of the leg 42 includes a gripping surface 46, which may be used to engage a cargo bed liner or the like. An inboard leg 43 depends from the top flange 40 in spaced relation to the outboard leg 42. A web 44 connects the legs in spaced relation to the top flange to form a generally rectangular box-shaped opening 45. The inboard leg 43 is apertured through into the box opening 45 to form a catch plate for a latch, to be described in more detail. The lower end of the inboard leg is generally configured in the shape of a J to form a drip channel 50. The leg includes an extension or flange 51 inboard of the channel for supporting a portion of a panel section 54. The flange includes a seat 52 for receiving a seal 53. The seal 53 is shaped for sealing contact with a lower leg of a side panel rail to be described, so as to prevent entry into the cargo bed area of any moisture that may collect in the drip channel 50. The forward end of the inboard leg extension 51 is apertured to receive bolts 34 or pivot members connecting the legs to the bottom flange 31 of the bed front rail 23.

The bed front and side rails 23, 24 and 25 are installed in spaced relation to the upper margin or rim of the cargo bed 4 so as to mount the cover assembly 15 in flush relation with the upper margins of the cargo bed walls and tailgate. This flush mount of the cover assembly 15 cooperates with the seals and gaskets of the bed rails, cover assembly and perimeter seal to produce a completely weatherproof and watertight installation and to maintain a dry cargo space within the covered cargo bed.

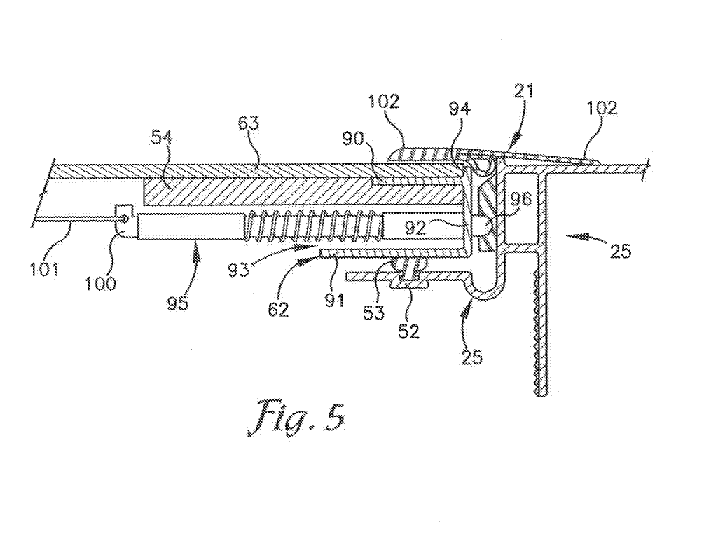

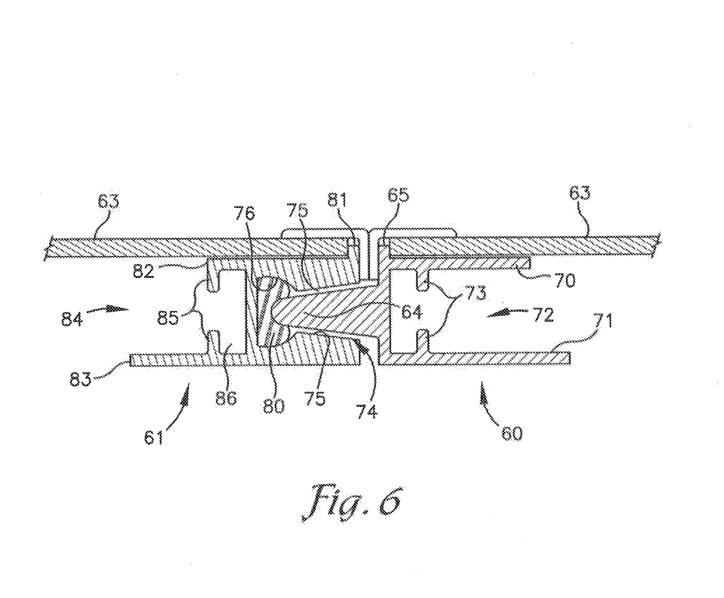

The cover assembly 15 includes a plurality of modular panel sections 54. Typically, the cover assembly 15 includes at least two panel sections, a forward panel section and an aft panel section. Any number of mid panel sections may also be included, so that 3, 4, 5, 6, 7, 8, 9, 10, or any number of panel sections may be installed to form the cover assembly. In an extremely long cargo bed, such a semi-trailer, as many as 20 panel assemblies may be employed. Each panel section 54 (FIGS. 5, 6) includes a panel member 55 bounded by a forward panel rail 60, a rear panel rail 61, a pair of side panel rails 62 and overlaid by a trim panel or inlay 63. The panels may be constructed of a fiber reinforced synthetic resin such as fiberglass, a synthetic resin or mixture of synthetic resins, or any other suitable material. The panel rails 60, 61, 62 may be constructed of channel molding, which may be extruded from aluminum, or any other suitable material, including other metals and synthetic resins.

As best shown in FIG. 6, the forward panel rail 60 is constructed of a material somewhat similar to U-channel molding having a closed, forward end provided with a projecting tongue 64. The tongue is depicted as having a generally triangular cross sectional profile, although it is foreseen a rounded, U-shaped, quadrilateral, or any other suitable shape may be employed. A flange 65 projects upwardly from the closed end to form a stop for a trim panel 63 to be described in more detail. The forward panel rail includes an upper leg 70 and a lower leg 71 with a space 72 therebetween for receiving the forward margin of a panel 55. A pair of grips 73 extend inwardly from the legs in spaced relation to the closed end to grip the panel and hold it in place.

The rear panel rail 61 is also constructed of a material similar to U-channel molding having a closed and filled end that is milled out to provide an opening 74 having a generally keyhole-shaped cross section. The rearward portion of the opening includes a groove 75 having a generally V-shaped cross section that is sized and shaped for reception of the tongue portion 64 of the forward panel rail 60. The forward portion of the opening includes a seal-shaped channel 76 that provides a seat for an elastomeric seal 80, such as a bulb seal. An upstanding flange 81 projects from the milled end to form a stop for a trim panel 63. The rear rail includes an upper leg 82 and a lower leg 83 defining a space 84 therebetween for reception of the rear margin of a panel 55. A pair of grips 85 extend inwardly from the legs, defining a space 86 adjacent the closed portion of the milled end.

The forward panel rail of a panel section 54 engages the rear panel rail of an adjacent panel section 54 by reception of the tongue 64 within the groove 75. The leading edge of the tongue 64 is received within the specially configured elastomeric seal 80 to provide a waterproof seal against the elements and to enable upward and downward tipping of the panel during engagement and disengagement from the adjacent panel section.

The side panel rails 62 (FIG. 5) are also constructed of a material similar to U-channel molding but having a closed end. The rail includes an upper leg 90 and a lower leg 91 connected by a web 92 that defines an interior space 93 for receiving a side margin of a panel 55. The upper leg 90 includes an upstanding flange 94 that forms a stop for a trim panel 63.

The panel rails 60, 61, and 62 are sized for reception between the bed front 23 and side 24, 25 rails and the tailgate 13 of the particular vehicle. The panels 55 are sized for reception within the rail spaces 72, 84, and 93. Trim panel inlay pieces 63 are provided to enable customization of the color and finish of the panel sections, and are sized for reception within the area formed by the upstanding front, rear, and side flanges 65, 81, and 94. The trim panel inlays 63 may be constructed of fiberglass, synthetic resin, or any other suitable weatherproof material which may include a smooth upper surface and may be paintable to enable an owner to customize or modify the color scheme of the panel assembly from time to time.

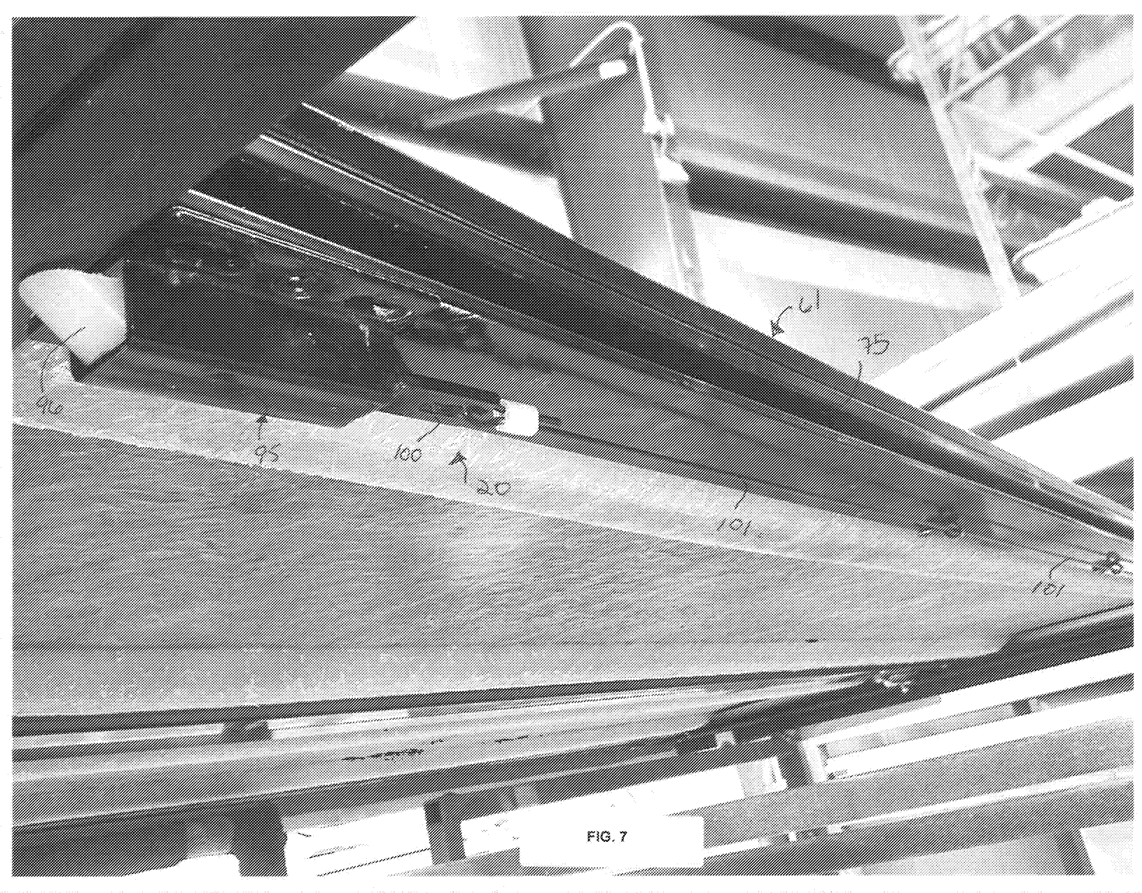

Each panel section 54 also includes a latch assembly 20 (FIG. 2) for releasably connecting the panel section with the cargo bed side rails. While virtually any type of latch may be employed, a spring loaded latch 95 is shown in FIGS. 5 and 7 as a non-limiting example of one type of latch. Each panel latch assembly 20 includes a pair of spring loaded latches 95 connected adjacent one of the respective side panel rails 62. Each latch includes a spring biased latch pin 96 connected with an apertured tail piece 100 for connection with a latch pull cable 101 that extends between the tail pieces of the respective latches. In a resting position, the latch pin 96 is biased by the spring to its extended position. The pull cable 101 is operable to release the spring, allowing the latch pins to retract and thereby release the side panel rails 62 from the cargo bed side rails 24 and 25.

In one embodiment shown in FIG. 5, the latches are mounted within the rear panel rails 61 so that the latch pin 96 is inboard of the side panel rail 62 and projects outwardly though the apertured side panel rail web 92 and through the apertured inboard leg 43 of the bed side rail and is received in the box space 45. In this manner, the inboard leg serves as a catch plate for the latch pin when it is in its extended, latched position.

In another embodiment best shown in FIG. 7, the latches are mounted inboard and below each of the rear panel rails 61. In its extended, latched position, the latch pins 96 slide below the inboard leg flanges 51 of the bed side rails 24 and 25 to urge the panel section 54 downwardly against the bed side rail flanges 51. This serves to compress the seal 52 between the lower legs 91 of the side panel rails 61 and the bed side rail flanges 51, forming a moisture proof barrier between the sides of the panel sections 54 and the cargo bed side rails 24 and 25.

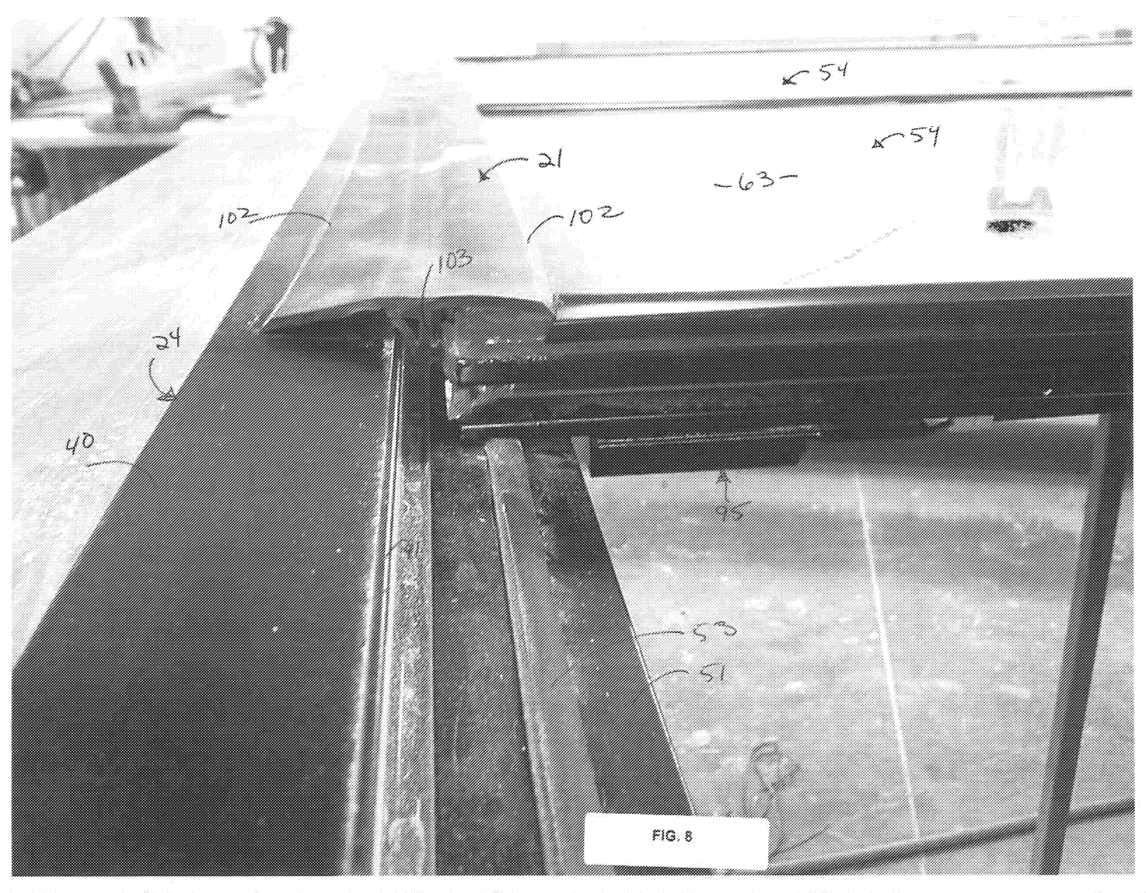

As shown in FIG. 8 the perimeter seal 21 is approximately T-shaped when viewed in cross section, including a top cap with a pair of drip edges 102 and a dependent leg 103. The leg is sized for reception in the space between the cover panel sections 54 and the bed forward and side rails, 23, 24 and 25, and the tailgate 13. The drip edge 102 is sized to overlie both the panel margins and the top surface of the frame members to completely cover the joint. The seal 21 may be constructed as a single unit, or in sections, in which case it may also be attached to the sides of the middle panel sections and to the front and sides of the forward panel section, as well as the rear and sides of the aft panel section. The seal 21 is constructed of an elastomeric material such as rubber, synthetic resin, or any other suitable material, and cooperates with the other seal members previously described to create a completely watertight and weatherproof seal to preserve the contents of the enclosed cargo bed.

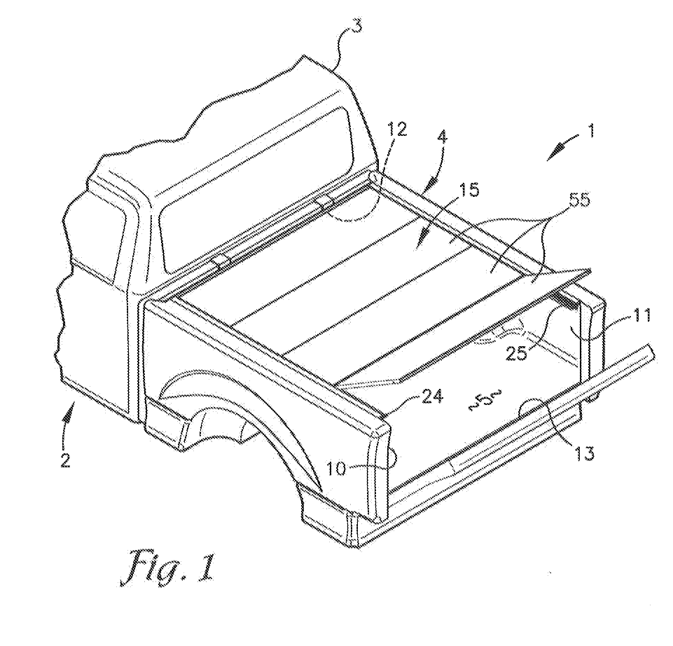

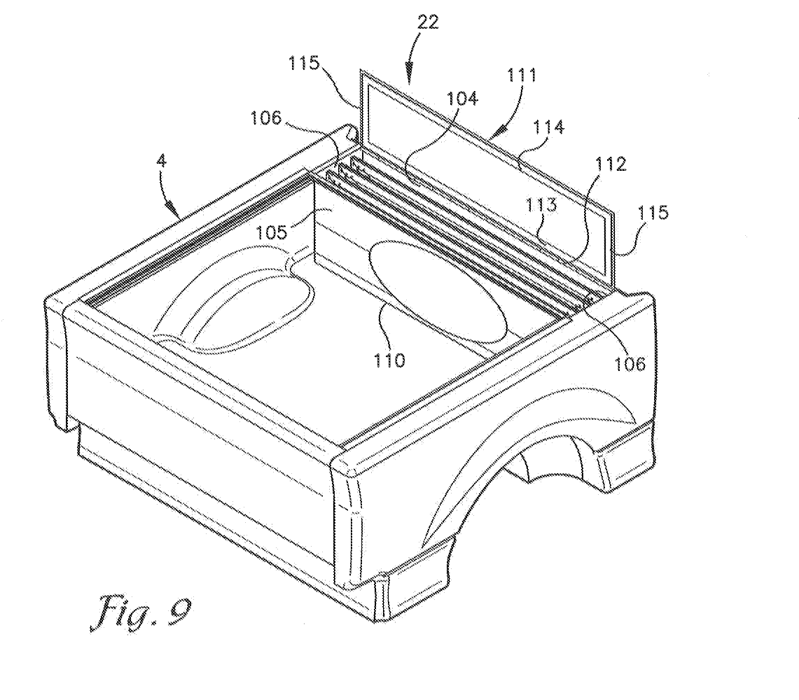

As shown in FIG. 9, an optional storage canister or trunk 22 includes a forward wall 104, a rear wall 105, a pair of sidewalls 106, a floor 110, and a lid 111. The lid is shown attached by a continuous hinge 112 (FIG. 1), although any hinge member, including a living hinge, may be employed. The lid includes front 113 rear 114 and side 115 panel rails as previously described as well as a trim panel 116 similar to that previously described. The front wall of the storage canister may also be removably connected with the forward bulkhead of the cargo bed by fasteners such as bolts or the like. A latch mechanism 120 as previously described is provided to enable the lid to be secured in the closed position. The canister is sized to receive from one to all of the panel sections 54 included in the cover assembly 15. The sidewalls 106 are equipped with a plurality of spaced apart vertically oriented ribs or ridges 121 that form a series of vertical slots for supporting one or more panel sections 54 in an upright position. In this manner, the storage canister 22 provides for convenient, protected storage of the cover panel sections as they are selectively or entirely removed.

The components of the vehicle bed cover system and storage assembly 1 may be fabricated to conform to virtually any sized cargo bed. The system may be custom fabricated and installed or it may be available in kit form for installation by a user. The frame assembly 14 is prefabricated to fit the cargo bed of a selected vehicle and installed, either by the fabricator or a user. The user is provided with a plurality of appropriately sized panel section assemblies 54, each equipped with a latch assembly 20. The user is also provided with a perimeter seal 21 sized to surround the cover assembly after it has been installed. If selected, a storage canister 22 has been prefabricated to fit the cargo bed and installed.

In a method of use, a user selects a first panel section 54, positions the projecting tongue 64 of the forward panel rail 60 toward the channel 33 of the bed front rail 23, pulls downwardly on the latch cable 101, releasing the left and right latch pins 96, enabling the panel section 54 to be dropped down to a level position, engaging the seals 54 on the leg flanges 51 of the bed side rail inboard legs 43, thereby providing a waterproof seal between the bottom of the panel section and the bed side rails 24 and 25. If necessary, the panel may be slid forwardly to urge the tongue 64 further into the channel 33 until it has fully engaged the gasket 35, thereby providing a waterproof seal between the forward margin of the panel and the bed front rail 23. The user releases the latch cable 101, allowing the latch pins 96 to advance laterally and engage the respective bed side rails 24 and 25, securing the panel in place. The user then selects a second panel section 54, orients it in the same manner, and repeats the steps, inserting the projecting tongue 64 into the corresponding groove 75 of the rear panel rail 62 of the first panel until the tongue engages the seal 80, thereby providing a waterproof seal between the rear margin of the first panel and the forward margin of the second panel. This step may be repeated any number of times to insert additional panels until the desired number of panels have been installed in the cargo bed. The installed bed cover system 1 cooperates with the vehicle tailgate to create a secure cargo transport and storage area. The cargo bed frame member, the panel segments and panel rails all cooperate to form a strong, rigid and complete protective system. In embodiments where the perimeter seal 21 is not incorporated into the panel sections as previously described, the user next installs the perimeter seal 21 by inserting the dependent leg 103 into the space between the panel sections 54 and the cargo bed frame until the drip edge 102 overlies both the respective panel margin and the top surface of the frame 14. In the case of the tailgate 13, the leg 103 is inserted into the space between the rear panel rail 61 and the top edge of the tailgate and the drip edge 102 overlies the rear panel margin and the top of the tailgate.

Once installed, the process is reversed to remove one or more panels. The bed cover system is uniquely flexible, and it is not necessary for a user to install or remove all of the panels in the cargo bed. One or more panel sections may be omitted or removed to enable the user to transport items, yet provide covering protection for the remainder of the cargo bed. This is particularly desirable where the cargo bed contains additional cargo items that might be damaged by the elements or blow out of the bed during transport. Advantageously, the panel construction provides lightweight panel sections with strong perimeter support, enabling panels to be omitted from not only the rear portion of the cargo bed, but also from the forward or middle portion of the bed. Additional panels may be inserted aft of the open space where panels have been omitted. In this manner, for example, a user may transport an item such as a tree having widespread branches, by positioning it in the middle of the cargo bed, with panels installed forward and aft to protect additional cargo items such as smaller plants from wind damage during transport. A single individual can install and easily add or remove the cover panel sections to create the bed of the vehicle into a secure storage compartment while allowing ease of use for hauling oversize cargo by removal of one or all of the panels.

In this manner the panels are interlocked together and multiple seals are engaged to form a cover system that works as a single unit to create a strong, secure and weatherproof covering for the cargo bed. Once installed, the cover system provides the cargo bed with a planar top surface that is essentially flush with the rim of the cargo bed to provide an aerodynamic cover system. The system is easily modified by removing one or more selected panels to accommodate cargo that extends above the rim of the bed, while retaining the covering system in place in the remaining areas.

Having described a vehicle bed cover system and storage assembly, it will be apparent to those skilled in the art that many changes, variations, modifications, other uses, and applications to the system and assembly are possible. Such changes, variations, modifications, other uses, and applications which do not depart from the spirit and scope of the invention are deemed to be covered by the invention, which is limited only by the claims which follow.

1. A modular cover system for a vehicle cargo bed having a deck, a forward wall, a pair of opposed sidewalls, and a rear wall, the system comprising:
a. a cover support frame mountable to the front wall and sidewalls of the vehicle cargo bed, the support frame including a forward bed rail and a pair of opposed bed side rails;
b. a plurality of cover panel sections, each panel section including a panel body bounded by a front panel rail, a rear panel rail and a pair of opposed side panel rails;
c. the panel rails each including upper and lower support legs forming a channel for receiving a portion of the panel therein;
d. the forward panel rail presenting a projecting tongue and the rear panel rail including a groove having a seal for receiving the tongue member of a forward adjacent panel in sealing relation, thereby sealing a joint between the panels;
e. the cover support frame bed rails each configured to receive the panels thereon;
f. each panel including a latch system operable to extend a latch outwardly from either side of the panel below the side bed rails for selectively securing the panel to the bed side rails or releasing the panel from the bed side rails, enabling a user to selectively release one or more panels from the cover system, thereby uncovering a selected portion of the cargo bed; and
g. a seal member configured for installation over a perimeter margin of the cover panels, the top surfaces of the support frame and upper edge of the tailgate of the cargo bed.

2. The modular cover system of claim 1, wherein the bed side rails each include a dependent drip channel and an inboard seal.

3. The modular cover system of claim 2, wherein the latch system is positioned below the rear panel rail and is operable to extend a latch from below either side of the panel below the bed side rails, urging the panel margin against the inboard seal in sealing relation.

4. The modular cover system of claim 1, wherein the forward, rear and side panel rails each include an upward projecting flange defining a space for receiving a removable trim panel.

5. The modular cover system of claim 1, wherein:
a. the bed side rails include a plurality of apertures;
b. the rear panel rail further includes a channel for reception of the latch assembly;
c. the latch assembly includes a latch pin that projects laterally from the rear panel assembly for engagement with selected ones of the apertures.

6. The modular cover system of claim 1, wherein the latch assembly includes a pair of spring loaded latch pins connected by a cable for operably releasing the pins.

7. The modular cover system of claim 1, wherein the perimeter seal includes a drip edge and a dependent leg, the leg sized for reception in a space between the side panel rails and the bed side rails and the forward panel rails and the forward bed rail and the rearmost panel rail and the tailgate.

8. The modular cover system of claim 1, wherein the latch assemblies are connected below the rear panel rail of each panel.

9. A modular cover system for a vehicle cargo bed having a deck, a forward wall, a pair of opposed sidewalls, and a rear wall, the system comprising:
a. a cover support frame mountable to the front wall and sidewalls of the vehicle cargo bed, the support frame including a forward bed rail and a pair of opposed bed side rails;
b. a plurality of cover panel sections, each panel section including a panel body bounded by a front panel rail, a rear panel rail and a pair of opposed side panel rails;
c. each front panel rail including a projecting tongue;
d. each rear panel rail including a groove for receiving the tongue of an adjacent panel;
e. the forward bed rail including a channel for receiving a front panel rail, the channel including a gasket for receiving the tongue of a front panel rail;
f. the side bed rail including a flange for receiving a panel section thereon;
g. the side bed rail flange including a seat supporting a seal member for sealing contact with a supported panel section;
h. the rear panel rails each including a groove member for receiving the tongue member of an adjacent panel;
i. the groove including a seal for sealing contact with the tongue member, thereby sealing a joint between adjacent panels; and
j. a perimeter seal configured for installation over a perimeter margin of the cover panels, the top surfaces of the support frame and upper edge of the tailgate of the cargo bed.

10. The modular cover system of claim 9, wherein:
a. the side bedrail flange includes a drip channel for collecting any fluid received between the side bedrail and a panel side rail.

11. A modular cover system and storage assembly for a vehicle cargo bed having a deck, a forward wall, a pair of opposed sidewalls, and a rear wall, the system comprising:
a. a storage canister mounted to the forward wall of the vehicle cargo bed, the storage canister including a front wall, a rear wall, a pair of sidewalls and a lid;
b. a cover support frame mountable to the rear wall of the storage canister and the sidewalls of the vehicle cargo bed, the support frame including a forward bed rail and a pair of opposed bed side rails;
c. a plurality of modular cover panels, each panel having a panel body bounded by a forward panel rail, a rear panel rail and a pair of opposed side panel rails;
d. the panel rails each including upper and lower support legs forming a panel channel for receiving and a portion of the panel therein;
e. the forward panel rail presenting a projecting tongue and the rear panel rail having a groove member with a seal for receiving the tongue member of a forward adjacent panel in sealing relation to seal the joint between the panels;
f. the cover support frame bed rails each configured to receive the panels thereon;
g. Each panel including a latch system operable to extend a latch outwardly from either side of the panel below the side bed rails for selectively securing the panel to the bed side rails or releasing the panel from the bed side rails, enabling a user to selectively release one or more panels from the cover system and uncovering a selected portion of the cargo bed; and
h. a seal member configured for installation over a perimeter margin of the cover panels, the top surfaces of the support frame and upper edge of the tailgate of the cargo bed.

12. The modular cover system and storage assembly of claim 11, wherein the storage canister lid further includes a lockable latch.

13. The modular cover system and storage assembly of claim 12, wherein the storage canister sidewalls include a plurality of ribs defining vertical slots for receiving a plurality of upstanding cover panels.
